(19) United States
(12) Patent Application Publication
(10) Pub. No.: US 2018/0367210 A1
(43) Pub. Date: Dec. 20, 2018

(54) PORTABLE VEHICULAR LONG-DISTANCE BROADBAND COMMUNICATION SYSTEM USING HORIZONTALLY-PLACED SECTOR ANTENNAS AGAINST UNBOUNDED GRADUAL YAW-ROTATIONS AND UP TO +-60 DEGREES ABRUPT PITCH-ROTATIONS

(71) Applicant: Jiejun Kong, Jurupa Valley, CA (US)

(72) Inventor: Jiejun Kong, Jurupa Valley, CA (US)

(21) Appl. No.: 15/623,400

(22) Filed: Jun. 15, 2017

(51) Int. Cl. H04B 7/185; H04W 88/04; G01S 7/00; H04W 4/04; H04L 29/08; H04W 28/16

(52) U.S. Cl. CPC H04B 7/18506; H04W 88/04; G01S 7/006; H04W 28/16; H04W 4/046; H04L 67/12; H04B 7/18584

(57) ABSTRACT

The invention being patented pertains to providing long-range high-speed broadband communication between two common vehicles at pairwise distance longer than 7 kilometers in the presence of vehicle mobility and rotation. We observe that, since common vehicles are driven by steering wheels or equivalence, the motion pattern of these common vehicles typically features gradual yaw-rotations within an angular speed limit defined by their steering mechanism, as well as unpredictable pitch-rotations due to lack of effective steering control along the pitch-axis. We take advantage of this observation, which has been ignored by the existing commercial communication systems so far, to invent a new communication system designed specifically for such mobile vehicular scenarios. As the result, the invention is able to instantly cope with up to ±D degrees abrupt pitch-rotations while all of the existing commercial communication systems must experience non-trivial mechanical delay.

### FIELD OF THE INVENTION

The field of the invention pertains generally to wireless data communication, more particularly point-to-point high-speed wireless broadband communication between two common vehicles (automobiles, boats, ships, buoys, rotorcrafts and blimps) at pairwise distance of as large as 7 kilometers to 30 kilometers, more particularly high-gain directional antennas are required in the point-to-point long-distance wireless communication, more particularly it is difficult to immediately align the directional antennas for two mobile and self-rotating vehicles.

For long-distance directional communication between two mobile vehicles, the invention possesses numerous benefits and advantages over existing commercial-off-the-shelf (COTS) communication systems. We observe that, since most surface vehicles (automobiles, boats and ships) and rotorcrafts or blimps are driven by steering wheels, steering helms or equivalence, the motion pattern of these common vehicles typically features gradual yaw-axis (horizontal circle) rotations within an angular speed limit defined by their steering mechanism, as well as unpredictable pitch-axis (back-and-forth) rotations due to lack of effective steering control along the pitch-axis. We take advantage of this observation, which has been ignored by the existing COTS systems so far, to invent a new COTS communication system designed specifically for such mobile vehicular scenarios. As the result, our invention is able to instantly cope with up to ±60 degrees abrupt pitch-rotations while all of the existing COTS communication systems must experience non-trivial mechanical delay.

### BACKGROUND OF THE INVENTION

High-speed broadband communication between two data network entities is common nowadays using existing COTS products from various wireless network device manufacturers like Ubiquiti and Cisco. Such products normally utilize channel bandwidth in the range between 10 MHz and 50 MHz to reach high data rate in the range from several Mbps to more than 100 Mbps. Due to the radio frequency used in these COTS devices (mostly around the unlicensed 2.4 GHz and 5.8 GHz in frequency, corresponding to approximately 12.5 centi-meters and 5.2 centi-meters in wavelength), it is difficult for the radio wave to bypass a small obstacle with a size comparable to the wavelength or to penetrate a solid obstacle thicker than several meters. Thus the constraint of line-of-sight (LoS) between the transmitter and the receiver is required in long distance broadband wireless communication.

Wireless transmission power is normally measured by two common metrics: (1) Maximum transmitter output power, fed into the antenna; and (2) Maximum Effective Isotropic Radiated Power (EIRP), transmitted into air after going through the antenna. The EIRP is approximated by simply adding the transmit output power, in dBm, to the antenna gain in dBi, and adding cable loss if there is loss in the cable feeding the antenna. In most national and international standards, for instance, in the United States, several of the FCC 47 part 15 rules govern the transmit power permitted in the unlicensed frequency bands. In all cases, including the least restrained fixed point-to-point cases, the maximum transmitter output power must not exceed 30 dBm (1 watt). In addition, the maximum EIRP is typically 4 watts (36 dBm), which is the sum of 30 dBm transmitter output power and 6 dBi antenna gain, except in a fixed point-to-point link scenario, where the maximum EIRP allowed is 30 dBm transmitter output power plus 23 dBi of antenna gain, for the 5.15-5.25 GHz and 5.725-5.85 GHz band (FCC 47 rules section 15.245, 15.247, 15.249, 15.407). Moreover, the antenna's physical size cannot be much larger than its underlying vehicle.

Considering these physical constraints in transmission power and antenna size, in order to achieve long-distance communications, for example ≥7 kilometers LoS distance, we have to use directional antennas rather than omni-directional antennas. With omni-directional antennas, the one-hop transmission range is typically less than 3 kilometers by the above-mentioned physical constraints. By switching to various types of high-gain directional antennas, the transmission range can effectively be extended to more than 10 kilometers, and in certain extremely ideal cases more than 100 kilometers.

Unfortunately, the existing COTS products only readily provide such long-distance wireless broadband connections for stationary entities. It is still a challenge to provide the same sort of services for mobile entities due to their spatial motions (i.e., relative spatial translations and self-rotations). See FIG. 1, in this article we will use the yaw-pitch-roll body axes defined by NASA for a vehicle. In below we assume that the line of sight between the transmitting vehicle and the receiving vehicle is along the roll-axis. A yaw-pitch-roll rotation can either be the result of a relative motion between the two vehicles or simply be a self-rotation.

1. Relative Rotations:
a) Relative-yaw-rotations: For two common vehicles that are 8 or more kilometers apart from each other, the typical yaw-axis angular speed caused by relative spatial translations is expected to be less than 0.07 radian/second (4 degrees/second) for two vehicles moving apart, each at the very high speed of 1000 kilometers/hour (e.g., of Elon Musk's futuristic high-speed bullet trains), along the tangent lines of their communication direction. However, the overall degree of such gradual yaw-rotations is unbounded.
b) Relative-pitch-rotations: For surface vehicles, relative-pitch-rotations are caused by high variations in the terrain. Nevertheless, the angle of elevation is only 53 degrees from a surface vehicle at the sea level to another surface vehicle 10 kilometers away at the top of Mount Everest (the highest mountain on earth), thus the corresponding relative-pitch-rotation is typically within our range of ±60 degrees even considering the most extreme terrain variation on earth.
c) Relative-roll-rotations: Relative-roll-rotations are caused by the self-rotations of both vehicles. See discussions in the self-roll-rotations below since both roll-rotations are the same case.

2. Self Rotations:
a) Self-yaw-rotations: Self-yaw-rotations of a typical vehicle are unbounded in overall degrees but with a gradual delay. Most vehicles cannot perform a yaw-axis full circle within certain time limit due to the physical limit in steering mechanisms. For example, in our product line we currently set the minimal time limit to 6-second, which means a yaw-axis angular speed less than 1 radian/second (58 degrees/second). Most vehicles available on the nowadays market is slower than this angular speed when doing self-yaw-rotations.
b) Self-pitch-rotations: For surface vehicles, pitch-axis self-rotations are typically caused by hillslopes for terrestrial vehicles or by waveflows for maritime vehicles. Large self-pitch-rotations are relatively uncommon. In particular, a more than ±60 degrees self-pitch-rotation corresponds to a slope steeper than 173% grade in US traffic signs.
   i. Terrestrial case: This is impossible for properly-running terrestrial vehicles because the world's steepest street is less than 40% grade per the Guinness records.
   ii. Maritime case: A properly-running maritime vehicle cannot stand in a position steeper than ±60 degrees on the pitch-axis for more than a brief moment. In a short while it will travel forward and enter a less steep position after hitting the trough of wave.
c) Self-roll-rotations: A roll-rotation itself does not affect radio transmission because the receiving vehicle stays at the same spot in the transmitting vehicle's radio radiation pattern in spite of arbitrary roll-rotations. This means that roll-rotations do not affect radio transmissions when the other two (yaw and pitch) axes are properly aligned. Please see more details in the “Discussion of extremely large pitch-rotation solution” in the Section “Detailed Description of the preferred embodiments”.

Therefore, for millions of common vehicles, such as automobiles, boats, ships, buoys, rotorcrafts and blimps, to enjoy long-distance broadband communication, a cost-efficient solution is needed at real time to align the directional antennas installed on both the transmitting vehicle and the receiving vehicle, in spite of gradual yaw-rotations of unbounded degrees and abrupt ≤±60 degrees pitch-rotations.

Metric of Yaw-Axis Angular Speed

In our current product line, the limit of yaw-axis angular speed is estimated to be about 1 radian/second (58 degrees/second) for most terrestrial and maritime vehicles such as automobiles, boats and ships. It is important to note that the value of 1 radian/second is merely an estimation for our current COTS product line rather than an imperative rule. Per customer's demand, this value can be increased to a larger value, e.g., 3.14 radians/second (180 degrees/second), by upgrading the mechanical rotaries.

Antenna Radiation Pattern and Antenna Gain

Unlike omni-directional antennas, a directional antenna helps a radio transmitter to increase the transmission range by concentrating its transmission energy into a smaller degree of arc rather than the full circle. FIG. 2 shows a sample azimuth radiation pattern of directional antennas. FIG. 3 shows a sample elevation radiation pattern of directional antennas. The transmission range is mainly determined by the main lobe of the radiation patterns.

Sector antenna is a special kind of directional antenna used in telecommunication basestation towers to provide sectional coverage of a spatial region. As shown in FIG. 4, a sector antenna is usually deployed in its vertical position. At this usual position, the typical azimuth radiation pattern of the antenna is shown in FIG. 5 for covering a horizontal surface area, and the elevation radiation pattern shown in FIG. 6 for covering a vertical area. Per FIG. 5, each sector antenna covers a sector with a central angle of 2D degrees on the horizontal surface area, 360/2D sector antennas installed vertically on the same tower can cover the full circle around the yaw-axis.

Since the transmission power for civil broadband communication devices is limited to 30 dBm per most national and international standards, the transmission range of a radio transceiver-antenna combo in our system is mainly determined by the variations in antenna pattern and antenna gain. As shown in FIG. 7, the transmission range covered by the main lobe of a directional sector antenna's radiation pattern increases as the arc degree of the sector decreases, or equivalently, as the antenna gain increases. In other words, the narrower the arc is, the larger the antenna's gain is, and the longer the radio transmission range is.

Surface Vehicle's Antenna Height and Actual LoS Communication Range

Considering that the effect of atmospheric refraction is negligible, distance to the horizon from an observer close to the Earth's surface is about

d≈3.57\sqrt{h}

where d is in kilometers and h is height above the ground level in meters. For example, for a 20-kilometer LoS distance between two identical vehicles, either vehicle must maintain a 10-kilometer distance to the horizon so that they can see each other's crown. The antenna height calculated is approximately 7.8 meters. Since every surface vehicle has a limited antenna height, the LoS distance between any two surface vehicles is also limited. The actual communication range of short-wavelength broadband radios is thus approximately the smaller one of the LoS distance and the radio transmission range in vacuum free space

communication range≈min(LoS distance,radio transmission range)

In other words, if the LoS distance is already smaller than the radio transmission range, then it is useless to increase the radio transmission range by using an antenna with larger gain.

In summary, for two communicating surface vehicles, we can estimate the LoS distance based on their antenna heights as well as the radio transmission range based on transmission power and antenna gains. When the radio transmission range is greatly larger than the LoS distance, we may consider switching to an antenna with smaller gain, so that other dimensions of the system's performance metrics, such as the sector range ±D, could be improved.

### OBJECTS OF THE INVENTION

It is an object of this invention to create a cost-efficient long-distance broadband communication system for millions of mobile vehicles. In particular, we observe the following constraints:
Common vehicles with rollover limits at first: This patent application only seeks to provide a solution for common civilian vehicles with rollover limits, i.e., terrestrial, maritime and aerial vehicles with limited pitch-axis and roll-axis rotations, such as automobiles, boats, ships, buoys, rotorcrafts and blimps, not including fixed-wing aircrafts and military aerial vehicles with unlimited rollover capability. Our solution for unlimited rollover aerial vehicles is a more complex one based on the solution being patented, thus will be addressed in a separated future work. In addition, it is not our intention to address all extreme cases in common vehicles. For an example of extreme case, it is well-known that even when omni-directional antennas are used, the zenith position on the antenna axis is in any transmitter's dead angle and cannot be covered. In summary, this patent only covers vehicles with common motion patterns, namely unbounded but gradual yaw-rotations and up to ±60 degree abrupt pitch-rotations. Extreme cases such as pitch-rotations larger than ±60 degree will be addressed in a separated future work as well.
Portability: The size and weight of a solution system must not exceed a reasonable proportion of the underlying vehicle's payload metrics. Its size must not exceed the size of the vehicle's payload cabin, and its weight must not exceed the vehicle's payload capacity.
Cost efficiency: The financial cost of a solution system must not exceed a reasonable proportion of the underlying vehicle.
Antenna alignment performance: The rotational angular speed of a solution system must be fast enough, by our estimation, greater than 1 radian/second (58 degrees/second) for common vehicles.

In regard to the one-hop transmission distance, we classify our systems into two main categories:
1. Our ≥20 kilometers mobile system (abbreviated as “20+km mobile system” in below) is less than 0.9 meter in diameter and less than 10 kilograms in weight (without external cover radome).
2. Our 10-20 kilometers mobile system (abbreviated as “10+km mobile system” in below) is less than 0.4 meter in diameter and less than 5 kilograms in weight (without external cover radome).

The rationale behind the common-vehicles-at-first constraint is that the rotational patterns of common vehicles are much simpler than the ones of some military vehicles. It is not atypical for some military vehicles, e.g., fighter jets, to perform unbounded pitch-rotations and roll-rotations. In contrast, a surface vehicle or a rotorcraft can hardly perform 180 degree (±90 degree) rollover. For most properly-functioning common vehicles, for example automobiles, boats, ships, buoys, rotorcrafts and blimps, the pitch-rotations and roll-rotations are normally bounded by the range between ±30 degrees, sometimes ±45 degrees and ±60 degrees. It is extremely rare for surface vehicles and rotorcrafts to rotate out of the range of ±60 degrees on the pitch-axis or the roll-axis. Usually ≥60 degrees rollover means accident for these common vehicles. Our first goal is to invent solutions for civilian vehicles running in these common scenarios. The extreme cases are left as future work not included in the patent application.

The portability constraint is satisfied on any vehicle with payload metrics greater than the above-mentioned diameter and weight values. The overall appearance of our system is similar to a maritime satellite Internet system, for example, KVH's TracPhone V7-IP. Thus our system can be installed on most common vehicles, to name a few, all motor vehicles driven by US class A/B/C license drivers, maritime buoys with 2 meters or more in diameter, maritime boats and ships with 4 or more passengers, and so on.

The cost efficiency constraint is addressed by our relatively low price tag. In year 2017, the price of a single unit of our 20+km mobile system is US$12,900, and the price of our 10+km mobile system is US$5,900 (for maritime vehicles) or US$2,900 (for terrestrial vehicles or aerial vehicles).

Both of our systems satisfy the antenna alignment performance constraint by supporting unbounded yaw-rotations and up to ±60 degree abrupt pitch-rotations. The yaw-rotations are counteracted gradually at a specific angular speed limit, currently set to 1 radian/second (58 degrees/second), while the pitch-rotations are solved instantly, i.e., with zero delay or infinite angular speed.

### SUMMARY OF THE INVENTION

For common vehicles, we have achieved a novel solution by integrating a horizontally-placed sector antenna on a digitally-controlled mechanical rotary unit. Suppose the line of sight between the transmitting vehicle and the receiving vehicle is along the roll-axis, our design is able to cope with gradual yaw-axis rotations of unbounded degrees and abrupt pitch-axis rotations up to ±60 degrees:
1. The original azimuth radiation pattern of the sector antenna becomes the vertical dimension to cover pitch rotations in an instant manner without incurring mechanical overheads. The center line of the sector antenna's vertical sector arc is pointed to the remote horizon line, thus the receiving vehicle is covered by the transmitting vehicle's radiation pattern in spite of ±D degree pitch-rotations, where D can be as large as 60 by modern technology.
2. Also the original elevation radiation pattern of the sector antenna becomes the horizontal dimension affecting yaw-rotations, which must be counteracted by a horizontal mechanical rotary driven by a digitally-controlled motor.
3. As in most low-orbit satellite antennas, we need not address the roll-rotations because they do not affect radio transmissions when the other two axes are properly aligned.

The invention has already been implemented as actual COTS products. The actual TCP data rate of our products measured in field tests at California sites can both reach 10 Mbps broadband speed at 20 kilometers distance for our 20+km mobile system, and at 10 kilometers distance for our 10+km mobile system. As of the date when this application is filed, no other COTS products on the global market have been able to implement the system being patented.

### BRIEF DESCRIPTION OF THE DRAWINGS

For a more complete understanding of the invention, reference is made to the following description and accompanying drawings, in which:

FIG. 1 Yaw, Pitch and Roll: the 3 body axes of a vehicle according to NASA;

FIG. 2 Azimuth radiation pattern of a directional antenna;

FIG. 3 Elevation radiation pattern of a directional antenna;

FIG. 4 Cisco AIR-ANT5117S-N sector antenna in its usual position;

FIG. 5 Azimuth radiation pattern of a Cisco AIR-ANT5117S-N sector antenna in its usual position covering horizontal areas;

FIG. 6 Elevation radiation pattern of a Cisco AIR-ANT5117S-N sector antenna in its usual position covering vertical areas;

FIG. 7 Main lobes of the same transmitter's azimuth radiation patterns under different sector's degrees of arc;

FIG. 8 A sector antenna is placed horizontally rather than vertically on the pan-tilt rotary table;

FIG. 9 The four main components of the system being patented;

FIG. 10 Roll-rotation's impact on communication is trivial when pitch-rotations are within ±D degree sector; and

FIG. 11 A solution for extremely large pitch-rotations: Using a pitch-axis swing seat to mitigate pitch-rotations.

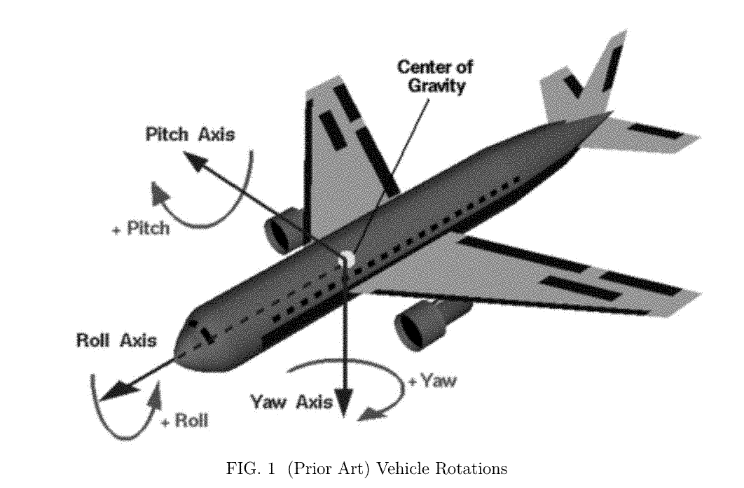

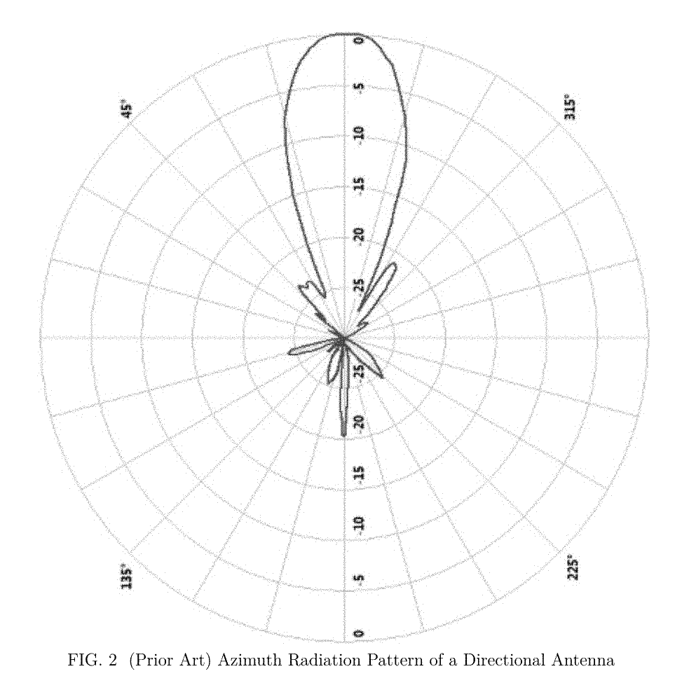

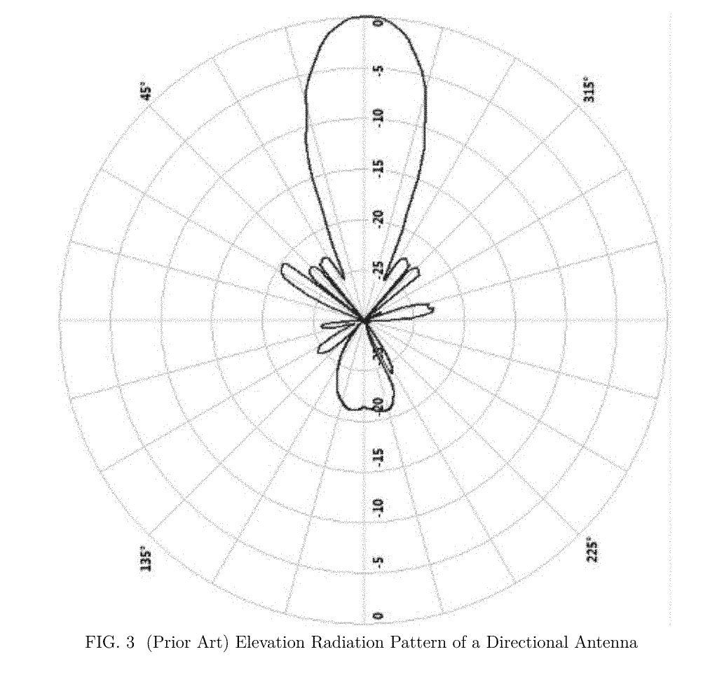

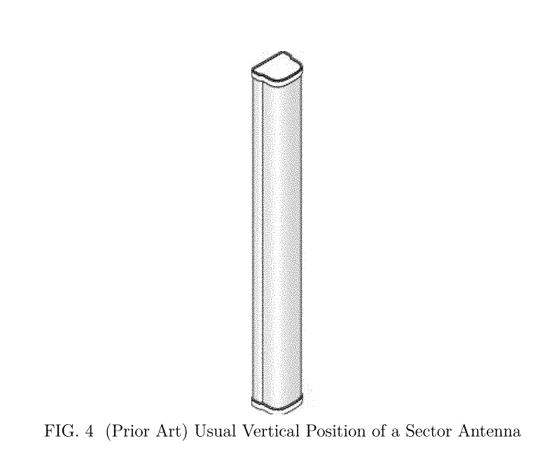

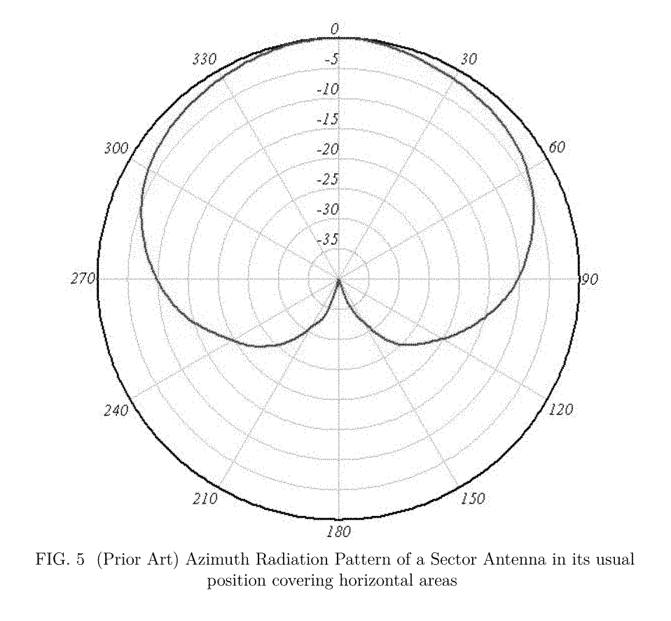

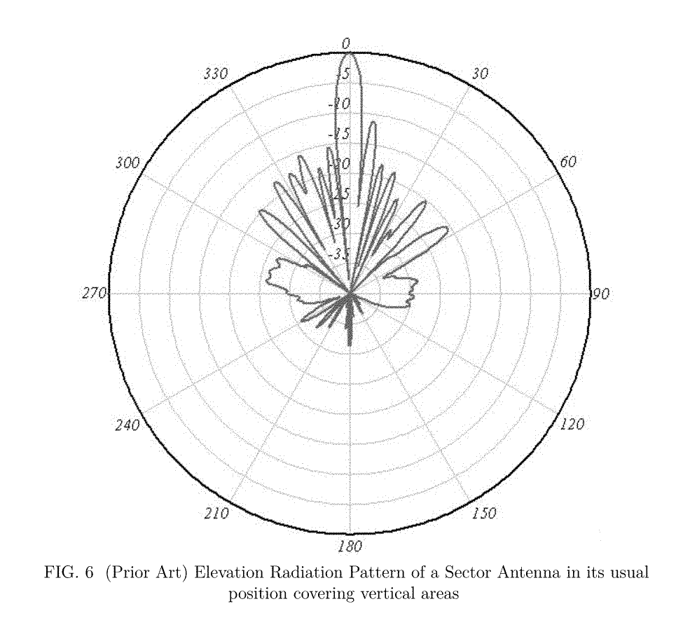

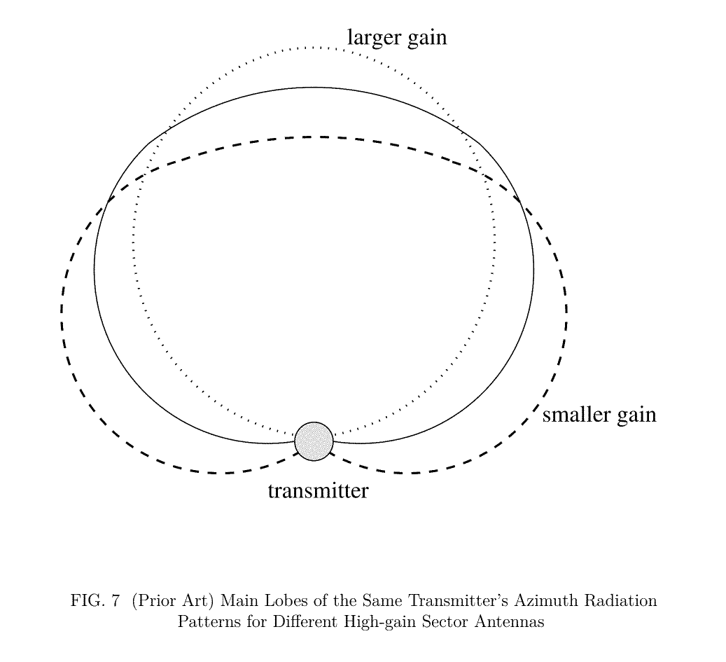

### DETAILED DESCRIPTION OF THE PREFERRED EMBODIMENTS

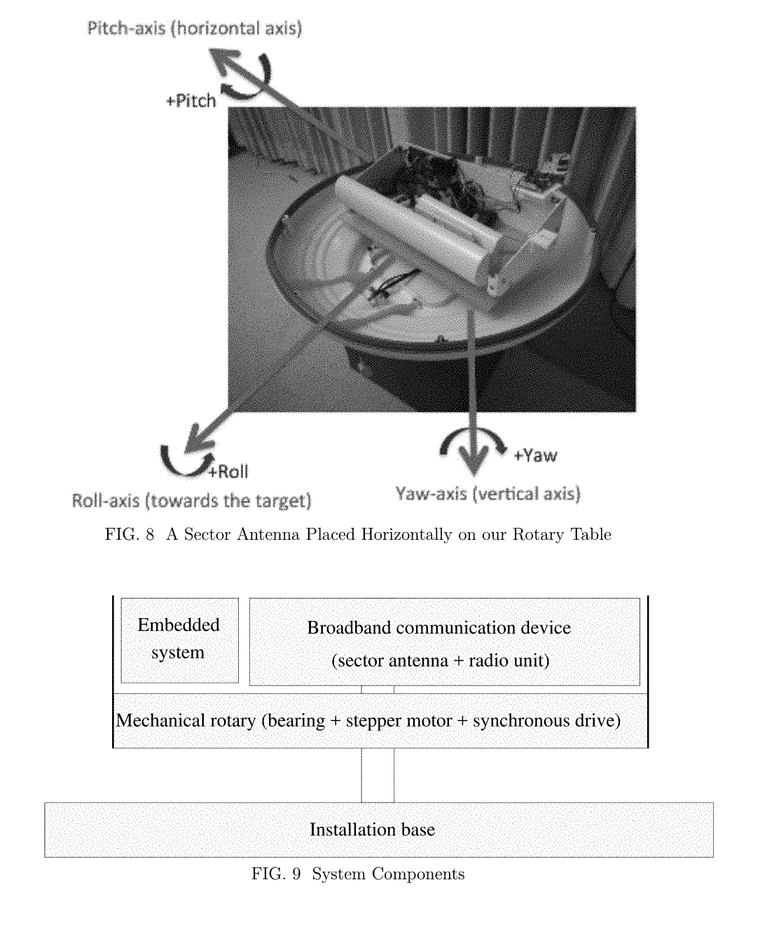

As depicted in FIG. 8, we use horizontally-placed sector antenna to achieve a novel solution to address the underlying vehicle's pitch rotations. Unlike the existing systems, our system instantly tolerates up to 120 degrees (±60 degrees) abrupt pitch-rotations with zero mechanical overhead, namely zero rotational delay and no extra energy consumption in the underlying mechanical subsystem.

The sector antenna and the radio transceiver unit installed in our system can be any COTS product, such as Ubiquiti's AirMAX & AirFiber product series, Cisco's AiroNet product series, and so on.
Our 20+km mobile system uses any COTS sector antenna with antenna gain in the range from 19 dBi (with ±60 degree sector) to 22 dBi (with ±22.5 degree sector) and a matching radio transceiver unit with transmission power in the range from 25 dBm to 28 dBm. Such a COTS sector antenna is typically 0.75 meter in length/diameter and weighs about 5 kilograms, while the radio unit is 0.3 meter in length and weighs about 0.5 kilogram. The actual devices used in our product line are Ubiquiti's AirMAX AM-5G19-120 (19 dBi, ±60 degree sector), AM-5G20-90 (20 dBi, ±45 degree sector) or AM-V5G-Ti/60 (21 dBi, ±30 degree sector) sector antenna connected with a Ubiquiti Rocket M5 radio unit. Our real measurements exercised at California sites show that the end-to-end TCP throughput from the mobile system to the home base-station is about 10 Mbps for AM-5AC22-45 at 21-kilometer distance and for AM-5G19-120 at 17-kilometer distance.
Our 10+km mobile system uses any COTS sector antenna with antenna gain in the range from 14 dBi to 17 dBi and a matching radio transceiver unit with transmission power in the range from 25 dBm to 28 dBm. Such a COTS sector antenna is typically 0.35 meter in length/diameter and weighs about 1 kilogram, while the radio unit is 0.3 meter in length and weighs about 0.5 kilogram. The actual devices used in our product line are Ubiquiti's AirMAX AM-5G16-120 (16 dBi, ±60 degree sector) or AM-5G17-90 (17 dBi, ±45 degree sector) sector antenna connected with a Ubiquiti Rocket M5 radio unit. Our real measurements exercised at California sites show that the end-to-end TCP throughput is about 10 Mbps for AM-5G-17-90 at 16 kilometer distance and for AM-5G16-120 at 14 kilometer distance.

As depicted in FIG. 9, our system is comprised of four main parts: a proprietary embedded system made by our company (Turing Network Test L.L.C.), a COTS broadband communication device, several rotary mechanical drivers and an installation base.
1. The proprietary embedded system functions as a network gateway for the vehicle's local area network. It has an accurate fluxgate compass to measure the current heading angle of the sector antenna, a GPS device to acquire its own location coordinates and a TCP/IP protocol stack to communicate with other network nodes. Currently we are using KVH-C100 fluxgate compass in our COTS product line. The accuracy of KVH-C100 is ±0.5 degree. When two vehicles communicate with each other, they must do two tasks: (1) pre-storing the other vehicle's initial location coordinates in the local storage of the embedded system, and (2) exchanging its current location coordinates with the other vehicle every T seconds where T ranges from a few seconds for fast-moving vehicles to several hours for stationary nodes like fixed basestations. This way, a vehicle calculates the heading angle towards the other vehicle based on both sets of coordinates, then aims its directional antenna accordingly. In fact, our embedded system maintains a table of target coordinates, and aims the directional antenna towards the nearest target in the table.
   a) For example, when stationary base-stations/access-points are deployed in the customer's wireless Internet access scenarios, we currently demand that the customer must store all base-stations' coordinates as a table in each vehicle's local storage. The embedded system selects the nearest one from the table and aims the directional antenna towards the nearest base-station. Once furnished with GIS terrain capability, “the nearest” metric is redefined to be “the most optimal” metric, for example, to enforce the line-of-sight constraint by knowing the terrain and avoiding obstacles, and also to enforce various routing constraints in the routing protocol packets. We are not trying to patent the “the nearest”/“the most optimal” design in this application. The reason why it is mentioned is to show that our design is viable in the real world.
   b) The coordinate information of a vehicle is textual data about 320 bits in size. We have developed a location coordinate broadcast protocol based on 30-kilometer long-range VHF/UHF digital radio, which is capable of transmitting data in 1200 bit-per-second speed which is capable of delivering the 320-bit textual data in a few seconds. The VHF/UHF digital radio channel acts as a control channel that exchanges important location information to establish the broadband data channel being patented. We are not trying to patent the long-range VHF/UHF digital radio control channel in this application. The reason why it is mentioned is to show that our design is viable in the real world.
2. A broadband communication device is a COTS product available from manufacturers like Ubiquiti and Cisco. In particular, a 15±2 dBi COTS sector antenna is typically 0.35 meter in length/diameter and weighs about 1 kilogram. A 20±2 dBi COTS sector antenna is typically 0.75 meter in length/diameter and weighs about 5 kilograms.
3. Sector antenna's horizontal rotary is a mechanical driver coping with yaw-rotations. It utilizes a slip-ring device to accomplish unbounded rotations around the yaw-axis. The horizontal rotary plate is fastened to the upper-half of a rotary bearing (e.g., a lazy susan bearing).
   a) An extra mechanical driver can be built to cope with extreme pitch-rotations that are larger than ±D degrees covered by the COTS sector antenna. This extra mechanical driver is not being patented in this application. It is mentioned to show that our solution is a complete one. Please see more details in “Discussion of extremely large pitch-rotation solution” in below.
4. The installation base is fastened to the lower-half of the rotary bearing.
5. The entire system can be enclosed in an external radome cover.

Discussion of Stationary Base-Station

The patent application is for our mobile systems only, not for the stationary base-stations. Like the cellular networks, in our application scenarios, a series of stationary base stations can be deployed at 20-kilometer distance, along a terrain path or along the coast line on the land, to provide gateway connections to the land based Internet for our mobile system. The mobile system will automatically point its directional antenna toward the nearest base station to establish the connection. Unlike our mobile system, a stationary base station is not restrained by antenna's physical size. In summary, larger antennas in physical weight and dimensions can be used by a base-station to communicate with our mobile systems.

Discussion of Mechanical Rotary

We do not enforce any imperative scheme to actualize the mechanical rotary as long as the rotary does its job to overcome yaw-rotations in the given time period. In our implementation, yaw-rotations are counteracted by the horizontal rotary driven by a digitally-controlled stepper motor with angular granularity of 1.8 degree and a highly-accurate fluxgate compass with ˜0.5 degree angular accuracy. The stepper motor is connected to the center of the rotary plate by a 1:N synchronous drive, where N ranges from value 3 to 12 in our actual products. Thus the angular granularity of the rotary plate is 1.8/N degree, namely at most 0.6 degree, which is comparable to the 0.5 degree accuracy of the fluxgate compass in use. The overall degree of yaw-rotations is unbounded due to the slip-ring's capability. The angular speed of yaw-rotations has a upper bound, which is currently 1 radian/second (58 degrees/second). This upper bound can be tuned up per customer's demands, for example, to be 3.14 radians/second (180 degrees/second), by using a 1:N synchronous drive with smaller N value and a faster stepper motor with larger torque.

Discussion of Extremely Large Pitch-Rotation Solution

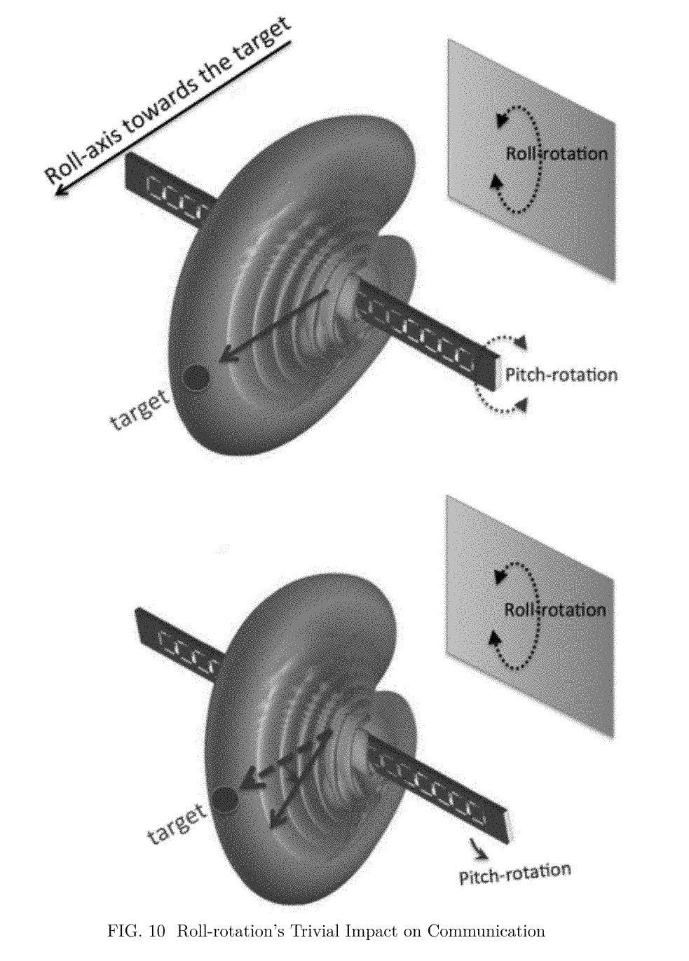

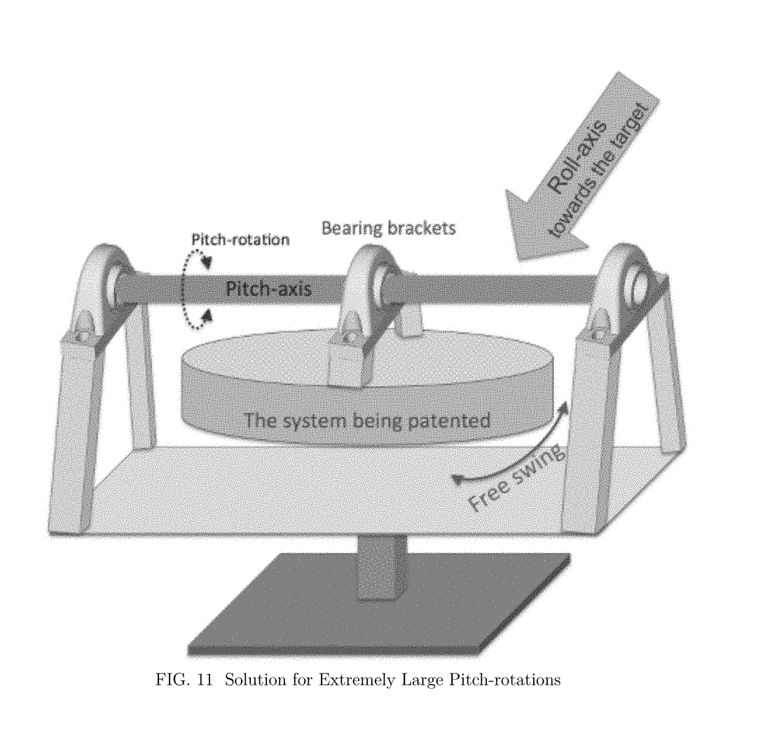

Our experiments confirm that TCP connections are hardly affected by the vehicle's roll-rotations. The reason is shown in FIG. 10. In spite of arbitrary roll-rotations, the target receiver stays in the transmitter's radiation pattern whenever the pitch-rotation is within the range of ±D degree of the underlying sector antenna. Only when the pitch-rotation at the moment is out of the range of D degree will the radio transmission fail to reach the receiver. We do not include solutions to extreme large pitch-rotations in this patent application. Nevertheless, here we briefly describe our solution to show that our design is indeed not vulnerable to extremely large pitch-rotations of the underlying vehicle. In FIG. 11, we implement a second larger mechanical rotary to align 3 bearing brackets along the pitch-axis towards the target vehicle. There are three free-rolling bearings: one for the swing seat of the system being patented and the other two for supporting the swing seat. This way, the system being patented will stay near the lowest vertical position of the swing seat due to gravity in spite of the vehicle's extremely large pitch-rotations, thus incurs negligible pitch-rotations on the sector antenna.

Caveats

It will thus be seen that the objects set forth above, among those made apparent from the preceding description, are efficiently attained and, because certain changes may be made in carrying out the above method and in the construction(s) set forth without departing from the spirit and scope of the invention, it is intended that all matter contained in the above description and shown in the accompanying drawings shall be interpreted as illustrative and not in a limiting sense.

It is also to be understood that the following claims are intended to cover all of the generic and specific features of the invention herein described and all statements of the scope of the invention which, as a matter of language, might be said to fall therebetween.

In this document, we use the following acronyms to refer to following entities that are needed to understand the patent application.
COTS means “Commercial off the shelf”. The term refers to commerical products available for sale on public physical sites such as local stores and factory outlets, as well as on public Internet sites such as Ebay, Amazon or product owner company's website. For example, Ubiquiti's antennas are available for sale on the company's public website http://www.ubnt.com/. Our products are available for sale on our company's public website http://www.turingnetworktest.com/. We argue that, if a COTS product is used in our system as a building component, our system is not violating any related patents of the COTS product because we have already paid market price to the seller who represents the interests of the patent owners.
LoS means “Line of sight”. The term describes a physical phenomenon that one party, denoted as A, can see the other party, denoted as B. There is no physical obstacle between A and B to block the propagation of the relevant electromagnetic waves.
FCC means “Federal communications commission”, the US federal agency regulating any practice related to radio communication.
EIRP means “Effective isotropic radiated power”. The term describes the electromagnetic radiation power emitted after the transmitter's antenna, while radio transmitter output power refers to the one before the transmitter's antenna.

What is claimed:

1. Suppose the line-of-sight (between the transmitting vehicle and the receiving vehicle) is along the roll axis, our invention being patented uses horizontally-placed sector antenna to provide high-speed broadband connections to a pair of common vehicles, with following rotational constraints satisfied:
a) The overall degree of yaw-rotations is unbounded. The angular speed of the corresponding mechanical rotary has a specific limit, which is currently set to 1 radian/second (58 degrees/second) for most terrestrial and maritime vehicles that are 7 or more kilometers apart from each other. This rotational limit can be tuned up per customer's demands by adjusting the mechanical rotary, currently we have implemented systems that can perform up to 3.14 radian/second (180 degrees/second) in angular speed.
b) The overall degree of pitch-rotations is ±90 degree by the science of geometry. The original azimuth radiation pattern described in the COTS sector antenna's specification can cover ±D degree pitch-rotations instantly, where D could be as large as 60 using nowadays COTS products. When the degree of a pitch-rotation is within ±D range, the pitch-rotation is solved instantly with zero delay without operating the mechanical subsystem. Otherwise, the pitch-rotation is extremely large (out of ±D range) and would be addressed by another mechanical rotary in a separated future work not included in the patent application.

2. For two common vehicles equipped with the system recited in claim 1, they can enjoy the wireless broadband services provided by the installed COTS radio units as if they are stationary, although they are actually experiencing unbounded yaw-rotations and up to ±60 degree abrupt pitch-rotations caused by the vehicle's mobility and rotation.

3. A vehicle knows its own geo-location coordinates using GPS devices or equivalence. The system recited in claim 1 has implemented a proactive network protocol to exchange location coordinates between the two communicating vehicles at real time with a fine granularity T, for example, T=10 seconds, so that a mobile vehicle can maintain the needed directional communication by computing the current heading angle towards the other side based on both vehicle's coordinates.
Consequently, for a pair of mobile vehicles, whenever they can exchange geo-location coordinates using a rate-limited slow-speed connection (e.g., via long-range slow-speed VHF/UHF packet radio or expensive satellite SATCOM data service), the system recited in claim 1 effectively establish a high-speed wireless link between the two vehicles, consequently transforms the rate-limited slow-speed wireless network connection into a rate-abundant high-speed one. Hence we name the system recited in claim 1 as “RRTransformer” (Radio Rate Transformer).
